(19) United States
(12) Patent Application Publication
(10) Pub. No.: US 2023/0361407 A1
(43) Pub. Date: Nov. 9, 2023

(54) A BATTERY ARCHITECTURE ALLOWING REUSABILITY OF COMPONENTS OF A BATTERY AND RECYCLABILITY OF BATTERY CELLS

(71) Applicant: ENERJAZZ TECHNOLOGY SOLUTIONS PVT. LTD., Madhya Pradesh (IN)

(72) Inventors: Pratik Ranjan Das, Noida (IN); Ravi Bharihoke, Noida (IN)

(21) Appl. No.: 18/029,906

(22) PCT Filed: Oct. 1, 2021
(86) PCT No.: PCT/IN2021/050950

§ 371 Date: Apr. 1, 2023

(30) Foreign Application Priority Data
Oct. 1, 2020 (IN) 202021042780

(51) Int. Cl. H01M 50/213; H01M 50/262; H01M 50/233; H01M 50/583; H01M 50/581; H01M 50/298; H01M 50/505; H01M 50/522; H01M 10/42; H01M 10/613; H01M 10/643; H01M 10/6562

(52) U.S. Cl. CPC H01M 50/213; H01M 50/262; H01M 50/233; H01M 50/583; H01M 50/581; H01M 50/298; H01M 50/505; H01M 50/522; H01M 10/4257; H01M 10/613; H01M 10/643; H01M 10/6562; H01M 2200/103; H01M 2010/4271

(57) ABSTRACT

An L-shape design of battery blocks (100) is described. Within each pair of the battery blocks (100), one L-shape battery block (100-1) may be placed at an angle of 180° to another battery block (100-2). A sufficient non-linear gap may be left within each pair of battery blocks (100) for natural cooling through movement of air. A bus-bar (200) developed by twisting of multiple pure copper wires may be used for connecting the battery blocks (100) with nuts and bolts. A fuse wire is used to connect at least one of the terminals of the cells (102) to the bus-bar (200). The battery blocks (100) may be placed in trays (300) having transparent walls (302) made of plexiglass. The battery blocks (100) may be packed together using a Velcro® and/or tension wrapped with wire before being placed in the trays (300).

### FIELD OF INVENTION

The present invention generally relates to a battery architecture. More specifically, the present invention relates to a modular battery architecture allowing reusability and easy repairing of components of batteries.

### BACKGROUND OF THE INVENTION

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

To increase energy density and to make maximum usage of existing space, current battery arrangements involve very compact placement of cells. Because the cells are compactly placed, air ventilation do not occur between them, and this reduces overall life of the batteries. Due to such compact placement of the cells, it very tedious to visually inspect condition of the cells. The cells or battery packs could only be inspected or repaired after disassembling all the battery packs. Further, disassembling the battery packs is also an onerous task because the cells are usually connected with each other using welding. In this manner, not only life but reusability of components of batteries get also reduced, and the batteries along with their supplementary components end up soon in landfills.

Currently, Electric Vehicles (EVs) account for only 0.1% of the global light-duty vehicle stock, and large-scale electrification of the road transportation sector seems challenging. The primary issue is the comparatively high retail cost of EVs, which are currently twice as expensive as their Internal Combustion Engine (ICE) equivalents. An EV battery pack accounts for up to 46% of this cost. Hence, possible cost reduction techniques, such as modification of the microstructure of existing electrode materials for lithium-ion (Li-ion) battery cells and the development of new battery are being pursued extensively by different research groups. These efforts have been partially successful, as the cost of manufacturing an EV battery pack reduced to around USD 210 per kWh in 2017-2018 from USD 1000 per kWh in 2007-2008. However, it is understood that the cost of battery packs must be reduced to below USD 100 per kWh to make EV battery packs cost-competitive and to enable large market penetration of EVs. It is, therefore, assumed that battery packs will continue to be the controlling factor in the costing of electric drivetrain architecture for the next 5 to 7 years. As time-to-market is becoming increasingly important for the success of any new product, it is vital to investigate other means of providing immediate economic benefits to EV battery pack users.

U.S. Pat. No. 5,534,366, owned by Motorola Inc., (Chicago, IL, USA) first disclosed the conceptual design of a battery pack that could meet this criterion. The patent claims to have modularized the battery pack in such a way that portions of the battery cell cartridge, the circuit cartridge and the housing can be shared and re-used. In addition, the battery cell cartridge can be replaced when required, without affecting other components of the system, thus making it a cost-effective solution for portable electronic devices.

Valence Technologies first developed the modular pack concept, which can be used from 12 to 1000V battery pack making using modules. It is equipped with an inter-modular balancing system. The design however does not include any ventilation/cooling system. At the 2013 IAA International Motor Show in Frankfurt, the Karlsruhe Institute of Technology (KIT) displayed another modular battery concept for electric city buses. In this concept, the size of the battery module can be adapted to different needs by changing the number of cells in each module. Important note is that in this concept, the battery cells themselves function as a crash barrier; however, these are taking the pouch/prismatic cells.

None of the conventional modular design is designed for easy repair of the battery pack. In most of the previous work, the voltage flexibility is achieved by using a DC-DC converter.

### OBJECTS OF THE INVENTION

A general objective of the invention is to achieve quick customization of battery system by allowing easy addition or removal of battery blocks.

Another objective of the invention is to offer a battery architecture that allows maximum reuse of components of the battery.

Yet another general objective of the invention is to offer a battery architecture that allows natural cooling to occur between battery blocks.

Still another objective of the invention is to offer a battery architecture that allows quick inspection of the batteries and easy assembly/disassembly of the batteries.

### SUMMARY OF THE INVENTION

This summary is provided to introduce aspects related to a battery architecture allowing reusability of components of a battery and recyclability of battery cells, and the aspects are further described below in the detailed description. This summary is not intended to identify essential features of the claimed subject matter nor is it intended for use in determining or limiting the scope of the claimed subject matter.

In one embodiment, an L-shape design of battery blocks is described. Within each pair of the battery blocks, one L-shape battery block may be placed at an angle of 180° to another battery block. Each battery block includes several cells which may be preferably placed in a vertical orientation. A sufficient non-linear gap may be left within each pair of battery blocks for natural cooling through movement of air. In other embodiments, other design of battery blocks, such as I-shape or bar-shape battery blocks could be utilized. A bus-bar developed by twisting of multiple pure copper wires may be used for connecting the battery blocks with nuts and bolts or similar other means allowing easy attachment and detachment. The battery blocks may be placed in trays having walls made of transparent plexiglass. The battery blocks may be packed together using a Velcro® or customized holders. Further, the battery blocks may be tension wrapped with wire before being placed in the trays. For quick assembly and disassembly, each battery block may be connected to a Battery Management System (BMS) using a separate connector.

In one implementation, a battery pack may comprise a plurality of battery blocks of L-shape configuration arranged in pairs. Two battery blocks present in each pair are positioned at an angle of 180° to each other. Each battery block may include a plurality of rechargeable cells. A non-linear air gap may be provided between each pair of the plurality of battery blocks to offer natural air cooling. The battery pack may further comprise a fuse wire connecting at least one terminal of each of the plurality of rechargeable cells with a bus bar made of metal wires twisted together. The bus-bar may be connected to the plurality of battery blocks using nuts and bolts for allowing quick assembling and disassembling. The fuse wire provides overcurrent protection and breakage of the fuse wire allows quick replacement of a corresponding faulty rechargeable cell without requiring disassembling of corresponding battery block. The battery pack may further comprise one or more trays for holding the plurality of battery blocks. The one or more trays may be made using one or more of wood, plastic, metal, glass, transparent plexiglass, or polypropylene. A Battery Management System (BMS) may be used for efficient monitoring and controlling of discharge current and temperature of the battery pack during operation.

In one aspect, the plurality of battery blocks may be secured together using one of a connector, rope, wire, or Velcro®, to address durability issues during transportation.

Other aspects and advantages of the invention will become apparent from the following description, taken in conjunction with the accompanying drawings, illustrating by way of example the principles of the invention.

### BRIEF DESCRIPTION OF THE DRAWINGS

The accompanying drawings constitute a part of the description and are used to provide a further understanding of the present invention.

FIG. 1 illustrates a block diagram of L-shape design of battery blocks, in accordance with an embodiment of current disclosure.

FIG. 2 illustrates a series connection of adjacent battery blocks, in accordance with an embodiment of current disclosure.

FIG. 3 illustrates an exemplary representation of a tray used to place battery blocks, in accordance with the embodiment of the present disclosure.

### DETAILED DESCRIPTION OF THE INVENTION

The detailed description set forth below in connection with the appended drawings is intended as a description of various embodiments of the present invention and is not intended to represent the only embodiments in which the present invention may be practiced. Each embodiment described in this disclosure is provided merely as an example or illustration of the present invention, and should not necessarily be construed as preferred or advantageous over other embodiments. The detailed description includes specific details for the purpose of providing a thorough understanding of the present invention. However, it will be apparent to those skilled in the art that the present invention may be practiced without these specific details.

Over the last few decades and across several sectors, including the automotive sector, modularity has emerged as a capable means to improve the economics of an industry. A modular design would allow Original Equipment Manufacturers (OEMs) to scale up a battery pack and meet the energy/power requirements of different Electric Vehicle (EV) applications, without necessitating major structural modifications to the basic pack architecture. This would enable mass production of battery cells, which in turn would reduce manufacturing costs for EV battery packs. In addition, it would enable OEMs to accommodate future uncertainties. A modular battery pack can therefore provide the much-needed traction to EVs by turning them into a compelling alternative to conventional Internal Combustion Engine (ICE) operated vehicles.

Current disclosure describes a modular architecture for batteries such as lithium-ion battery packs which are compact in nature. Proposed battery architecture allows easy disassembly, repair, and upgrade of several components of a battery. Proposed battery architecture also increases energy density of a modular battery system, allows in their easy assembling by making use of battery blocks and connecting such battery blocks for making battery packs. Further, methods for easy assembling/disassembling of the battery blocks are also described. Such battery architecture and the method of assembling/disassembling are described below in greater detail.

Proposed battery architecture also allows air flow to occur through specific gaps provided between each battery pack. Such air flow results in inherent cooling of cells of the battery packs.

Proposed battery architecture can be used to make both modular and high energy density battery packs by battery pack/module manufacturers for Electric Vehicles (EVs). The modular design is intended to achieve circularity in material and resources reuse. Proposed battery architecture can be used for both new cell packs (first life) as well as second life (re-purpose) battery packs.

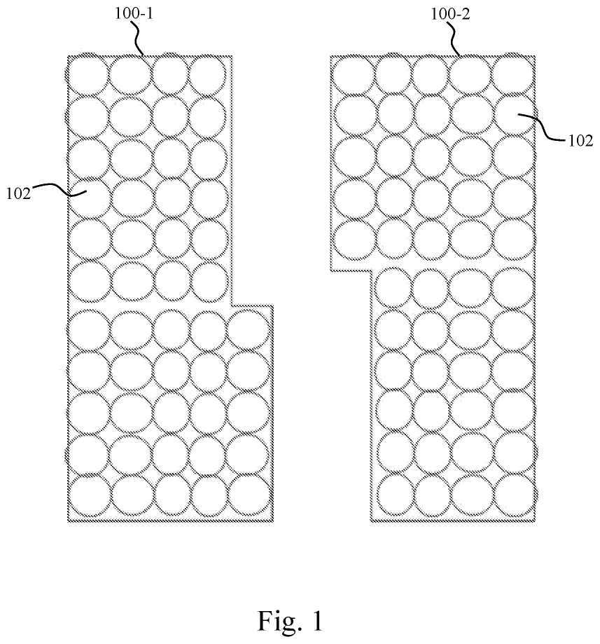

FIG. 1 illustrates a block diagram of L-shape design of battery blocks. Each battery block 100-1 and 100-2 (commonly referred as 100) shall have the L-shape design. A first battery block 100-1 will be arranged at an angle of 180° to a second battery block 100-2, as illustrated in FIG. 1. Each battery block 100 includes several cells 102. In one implementation, cylindrical lithium ion cells may be used to prepare the battery block 100.

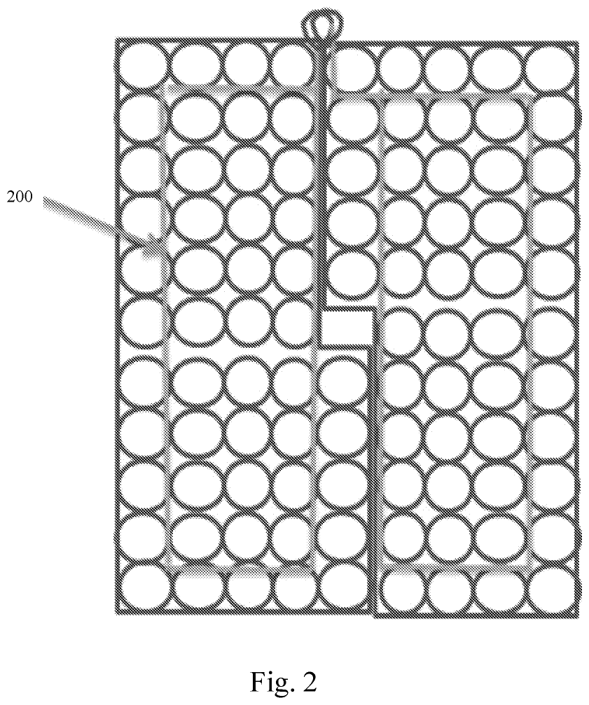

FIG. 2 illustrates a series connection of the adjacent battery blocks 100. Due to L-shape of the battery blocks 100, their combination is very compact. With such arrangement, energy density of the packs gets increased because more cells 100 can be put in same amount of space. Usage of L-shape of the battery blocks 100 allows quick customization of total voltage and total capacity of battery by addition or removal of one or more battery blocks 100.

In alternate embodiments, other design of battery blocks, such as I-shape or bar-shape battery blocks could be utilized. It should be understood that the I-shape battery blocks indicate battery blocks having a linear shape. The I-shape battery blocks would allow natural air to pass in a linear flow, without causing any obstruction to the air flow. Certain space may be left between each I-shape battery block to allow flow of air for natural cooling of the battery blocks. In some implementations, a mix of different designs of battery blocks could also be utilized, for example, an I-shape battery block could be positioned next to two L-shape battery blocks arranged at an angle of 180° with each other, and subsequently other two L-shape battery blocks could be positioned. In this manner, different arrangements, such as LL-I-LL or I-LL-I arrangements of the battery blocks could be used.

In other implementations, other design of battery blocks, such as square shape or rectangle shape battery blocks could be utilized. The battery blocks of square shape or rectangle shape may be used solely or in combination with battery blocks of other shapes, such as the L-shape or I-shape battery blocks. Battery blocks of different shapes could be used based on size and cooling requirements.

In one embodiment, a bus-bar 200 may be used for connecting the battery blocks 100. In one implementation, the bus-bar 200 may be developed by twisting multiple metal wires together, such as wires made using one of iron, copper, and aluminum. The metal wires may be twisted by rotating them together at a speed of about 500 rpm. During such process, a minimum amount of metal i.e. minimum number of metal wires may be used. The twisted metal wires could be flattened and used to connect terminals of the battery blocks 100, to provide modularity to design of a battery pack. Further, the bus-bar 200 can be connected to the battery blocks 100 by nuts and bolts or similar other mechanisms that could assist in easy and quick assembling and disassembling of the battery blocks. Alternatively, the cells could be connected to the bus-bar 200 by soldering or other similar means.

Further, the battery blocks 100 could be connected to a Battery Management System (BMS) using easily detachable connectors. The BMS may include a processor and a memory. The memory may store programmed instructions executed by the processor. The programmed instructions may be directed to increase battery life by efficient monitoring and controlling of discharge current and temperature of the battery pack during its operation. The BMS may be designed to receive charging current from a suitable charger.

Further, a non-linear air gap is also present between two L-shape battery blocks 100 in order to offer natural air cooling. In order to keep the space usage minimum and to avoid any safety issues that could come from keeping the battery blocks 100 horizontally on top of each other, the battery blocks 100 can be kept vertically.

Over current protection can be provided to each cell 102 using fuse wires that connects at least one of the positive or negative terminals of cells 102 to the bus-bar 200. The bus-bar 200 is further connected with a main circuit for receiving current for charging of cells 102 and providing current from the cells 102 to a load. At high current, the fuse wire breaks or melts, disconnecting the cell 102 from the bus bar 200 and the cell 102 is protected, thereby ensuring the safety of the cells 102. Additionally, when a cell 102 becomes faulty, the fuse wire connected with the cell 102 breaks and the cell 102 gets disconnected from the battery block 100. The faulty cell 102 can then be easily and quickly replaced from corresponding battery block 100 without requiring disassembling of corresponding battery block (100).

L-shape of the battery blocks 100 allows for their easy removal for second life applications after end of first life of batteries and other components present in the battery blocks 100.

In one embodiment, 7S and 6S series battery blocks may be used. 7S series battery blocks indicate seven battery blocks 100 positioned in a tray. Similarly, 6S series battery blocks indicate six battery blocks 100 positioned in a tray. For quick assembly and disassembly, each of the 7S and 6S series battery blocks may be connected to the BMS using separate connectors. Before being placed inside the tray, the battery blocks 100 may be packed together using a connector, rope, wire, or Velcro® or customized holders, to address durability issues during transportation. Further, the battery blocks may be tension wrapped with wire, to ensure that vibrations do not occur between the battery blocks 100. Such design can work for different series combinations of the battery blocks 100.

Usage of separate trays allow maintenance work to be carried upon a damaged battery block without disturbing battery blocks placed in other trays. In this manner, every battery block 100 can be placed in a single tray. The trays may be made of different materials or a combination of different materials, such as wood, plastic, metal, and glass.

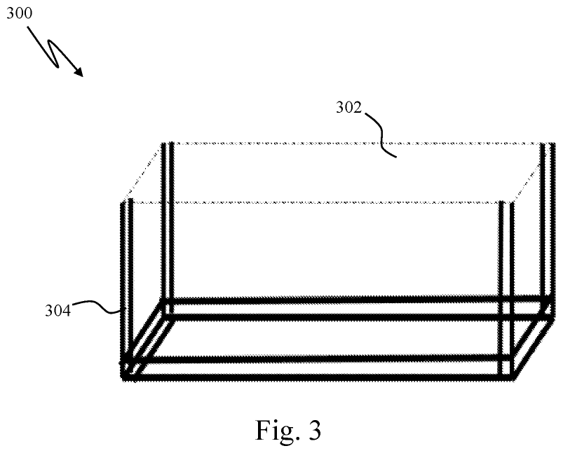

FIG. 3 illustrates one embodiment of the tray 300 including transparent walls 302 made up of materials such as glass, plastics, transparent plexiglass or polypropylene sheets. Such transparent walls 302 would allow quick visual inspection of the battery blocks 100, such as to inspect damage to any battery block or to see if the bus-bar has been detached and easily fix or replace the any damaged battery block.

The battery tray 300 also includes a base 304 made of a metal. When the tray 300 is made using a metal and put in direct contact with metal outer boxes, the tray 300 may assist in natural dissipation of heat. Multiple trays could be placed to leave enough space, for air to flow, to keep the battery packs naturally cool. The trays may also provide support to the battery blocks 100 to keep them in place.

Implementing the above described one or more embodiments, modular battery packs could be prepared for different purposes such as for electric vehicles. Such modular battery packs would ensure maximum reuse/recycling of several components of the battery packs, thereby increasing overall economy of the battery packs. Such components of the battery packs include, but are not limited to cell holders, fuse wire, protection circuit boards, nuts and bolts, bus-bars, and the Velcro®. In this manner, the components of the battery packs could be used for a longer time span of about 12-15 years, which is much higher than life of the battery itself (typically ranging from 2-8 years).

In the above detailed description, reference is made to the accompanying drawings that form a part thereof, and illustrate the best mode presently contemplated for carrying out the invention. However, such description should not be considered as any limitation of scope of the present unit. The structure thus conceived in the present description is susceptible of numerous modifications and variations, all the details may furthermore be replaced with elements having technical equivalence.

1. A battery comprising:
a plurality of battery blocks including a plurality of rechargeable cells, wherein the plurality of battery blocks comprise at least one of an L-shape configuration, an I-shape configuration, a square shape configuration, or a rectangle shape configuration.

2. The battery as recited in claim 1, wherein the plurality of battery blocks of the L-shape configuration are arranged in pairs, and wherein two battery blocks present in each pair are positioned at an angle of 180° to each other.

3. The battery as recited in claim 2, further comprising a non-linear air gap between each pair of the plurality of battery blocks of the L-shape configuration for natural air cooling.

4. The battery as recited in claim 1, wherein the plurality of battery blocks are positioned in an LL-I-LL arrangement or an LLL-I arrangement.

5. The battery as recited in claim 1, wherein the plurality of battery blocks are secured together using one of a connector, a rope, a wire, or hook and loop fasteners, to provide durability during transportation of the battery.

6. A battery pack comprising:
a plurality of battery blocks including a plurality of rechargeable cells, wherein at least one terminal of each of the plurality of rechargeable cells is connected to a bus bar using a fuse wire to provide an overcurrent protection and a thermal runaway protection, and wherein a breakage of the fuse wire allows a quick replacement of a corresponding faulty rechargeable cell without disassembling a corresponding battery block.

7. The battery pack as recited in claim 6, wherein the bus bar comprises metal wires twisted together.

8. The battery pack as recited in claim 6, wherein the bus bar is connected to the plurality of battery blocks using nuts and bolts for a quick assembly or a quick disassembly of a connection between the bus bar and the plurality of battery blocks.

9. The battery pack as recited in claim 6, wherein the plurality of battery blocks are held together in a tray comprising one of a wood, a plastic, a metal, a glass, a transparent plexiglass, or a polypropylene.

10. The battery pack as recited in claim 6, further comprising a Battery Management System (BMS) for monitoring and controlling a discharge current and a temperature of a battery pack during an operation of the battery pack.

11. The battery pack as recited in claim 6, wherein the plurality of rechargeable cells comprise new cells or recycled cells from used batteries.

12. A battery pack comprising:
a plurality of battery blocks of an L-shape configuration arranged in pairs, wherein two battery blocks in each pair are positioned at an angle of 180° to each other, and each battery block includes a plurality of rechargeable cells
a non-linear air gap between each pair of the plurality of battery blocks for natural air cooling;
a fuse wire connecting at least one terminal of each of the plurality of rechargeable cells with a bus bar comprising metal wires twisted together, wherein the fuse wire provides an overcurrent protection and wherein a breakage of the fuse wire allows a quick replacement of a corresponding faulty rechargeable cell without a disassembly of a corresponding battery block;
one or more trays for holding the plurality of battery blocks; and
a Battery Management System (BMS) to monitor and control a discharge current or a temperature of the battery pack.

13. The battery pack as recited in claim 12, wherein the bus bar is connected to the plurality of battery blocks using nuts and bolts.

14. The battery pack as recited in claim 12, wherein the plurality of battery blocks are secured together using one of a connector, a rope, a wire, or hook and loop fasteners.

15. The battery as recited in claim 1, wherein the plurality of battery blocks are held together in a tray comprising one of a wood, a plastic, a metal, a glass, a transparent plexiglass, or a polypropylene.

16. The battery as recited in claim 1, further comprising a Battery Management System (BMS) to monitor and control a discharge current or a temperature of the battery.
